(19) United States
(12) Patent Application Publication
(10) Pub. No.: US 2003/0003805 A1
(43) Pub. Date: Jan. 2, 2003

(54) Cable connector

(76) Inventor: Takashi Yamamoto, Osaka (JP)

Correspondence Address: Parkhust & Wendel, Suite 210, 1421 Prince Street, Alexandria, VA, 22314-2805, US

(21) Appl. No.: 10/181,555

(22) PCT Filed: Jan. 29, 2001
(86) PCT No.: PCT/JP01/00588

(30) Foreign Application Priority Data
Feb. 3, 2000 (JP) 2000-025789

(51) Int. Cl. H01R 9/03

(52) U.S. Cl. 439/610

(57) ABSTRACT

The present invention is devised to provide an XSR cable connector with satisfactory extraneous emission performance. An outer conductor (2) of a cable (1) extends from the inside to the outside of a chuck (9) through the space between an outer jacket (4) of the cable and the rear end portion (9c) of the chuck (9) so as to be interposed between the outer peripheral surface of the chuck (9) and the inner peripheral surface of a housing (8). Hence, the outer conductor (2) of the cable is in contact with the inner peripheral surface of the housing (8) not at a point but on a surface for conduction, allowing the housing to be at the same potential as that of the outer conductor in terms of high frequency waves, remarkably improving extraneous emission of high frequency harmonics nose from the side of the housing as compared with the prior art.

### TECHNICAL FIELD

The present invention relates to an XSR cable connector generally used in the field of audio products for professional use.

### BACKGROUND ART

A typical XSR cable connector is configured as shown in FIGS. 6 and 7. Here, a male XSR cable connector will be described as an example.

A cable 1 is a twist pair cable formed of wires 3L, 3R and an outer conductor 2 that shields the same wires, and the outside of the outer conductor 2 is protected by an outer jacket 4. The XSR cable connector is assembled as follows: the wires 3L and 3R are soldered to male contacts 6a and 6b of an insert 5, the outer conductor 2 is soldered to a male contact 6c of the insert 5 and a leaf spring terminal 6d, and the insert 5 is inserted from the rear of a housing 8 made of conductive metal.

At this point, a chuck 9 made of insulating resin covers the rear of the insert 5. A slit 9a is formed on the side of the chuck 9, and a tapered part 9b is formed on the rear end.

Further, an internal thread 10a of a bushing 10, which is inserted to the rear of the chuck 9 and is made of insulating resin, is screwed onto an external thread 8a of the housing 8.

Hence, a leading end of the chuck 9 is brought into contact with the insert 5, the tapered part 9b on the rear end of the chuck 9 is pressed by an inner peripheral surface 10b of the bushing 10 as shown in FIG. 7, and a rear end portion 9c of the chuck 9 catches and holds the outer jacket 4 of the cable 1.

In the above conventional configuration, as shown in the state of assembling in FIG. 7, the housing 8 is connected to the outer conductor 2 of the cable 1 via the leaf spring terminal 6d, which is in contact with a part of the inner periphery of the housing 8, and the rear of the insert 5 is surrounded by the rear of the housing 8 which is connected to the outer conductor 2 of the cable 1 via the leaf spring terminal 6d.

However, since a handled signal has increased in frequency as audio video systems have recently improved in quality, improvement in high frequency characteristics has been demanded for XSR cable connectors under the present circumstances.

As a specific example, the following example will be discussed: a baseband signal receives a digital signal of 6 MHz (6 Mbps) via an XSR cable connector.

Considering the state of assembling in FIG. 7 at the above handled frequency, the housing 8 at the rear of the insert 5 has insufficient shielding effect, and an undesired signal S1 may be leaked from this part to the outside.

Moreover, when frequency components of the undesired signal S1 are examined, it is found that the leakage of high frequency harmonics nose is noticeable. This is because a contact point P1 with the leaf spring terminal 6d is only one secure contact point of the housing 8, a rear A of the housing 8 in terms of high frequency harmonics nose is equivalent to an antenna grounded at the contact point P1, and the undesired signal S1 is also emitted from the side of the housing 8.

### DISCLOSURE OF INVENTION

The present invention is devised to solve the above described problem and has as its object the provision of an XSR cable connector which can handle a baseband signal having a higher band with satisfactory high frequency characteristics.

An XSR cable connector according to claim 1, in which an outer periphery of an insert having a contact is covered with a conductive housing, a chuck having the leading end being in contact with the insert is inserted into the housing at the rear of the insert, the rear end of the chuck is pressed in the inner periphery of a bushing mounted on the rear end of the housing, and a cable is caught and held at the rear end of the chuck, is characterized in that an outer conductor of the cable or a conductor connected to the outer conductor extends from the inside to the outside of the chuck through the space between an outer jacket of the cable and the rear end portion of the chuck so as to be interposed between the outer peripheral surface of the chuck and the inner peripheral surface of the housing and the conductor is brought into contact with the housing.

An XSR cable connector according to claim 2 of the present invention, in claim 1, is characterized in that a conductive tape is wound around the outer peripheral surface of the chuck via the outer conductor of the cable or the conductor connected to the outer conductor which extends from the inside to the outside of the chuck and is folded on the outer periphery of the chuck, and the conductive tape is brought into contact with the inner peripheral surface of the housing.

An XSR cable connector according to claim 3 of the present invention, in claim 1 or 2, is characterized in that the conductor connected to the outer conductor of the cable is a cylindrical braided wire.

An XSR cable connector according to claim 4 of the present invention, in claim 1 or 2, is characterized in that the cable has an outer conductor composed of a double braided wire, and the outer braided wire of the outer conductor extends from the inside to the outside of the chuck and is folded on the outer periphery of the chuck.

An XSR cable connector according to claim 5 of the present invention is characterized in that at least a part of the chuck is made of a conductive material, the outer conductor of the cable or the conductor connected to the outer conductor is interposed between the outer jacket of the cable and the rear end of the chuck so as to bring the chuck and the outer conductor of the cable into conduction, and the outer conductor of the cable is brought into contact with the inner peripheral surface of the housing via the chuck.

An XSR cable connector according to claim 6 of the present invention is characterized in that at least a part of the chuck is made of a conductive material, the outer conductor of the cable or the conductor connected to the outer conductor is interposed between the outer jacket of the cable and the rear end of the chuck so as to bring the chuck and the outer conductor of the cable into conduction, and the outer conductor of the cable is brought into contact with the inner peripheral surface of the housing via a conductive tape wound around the outer periphery of the chuck.

### BRIEF DESCRIPTION OF DRAWINGS

FIG. 1 is a sectional view showing a state of assembling a male XSR cable connector according to Embodiment 1 of the present invention;

FIG. 2 is a perspective view showing an assembling process of Embodiment 1;

FIG. 3 is a sectional view showing a state of assembling a male XSR cable connector according to Embodiment 2 of the present invention;

FIG. 4 is a perspective view showing an assembling process of Embodiment 2;

FIG. 5 is a sectional view showing a state of assembling a male XSR cable connector according to Embodiment 3 of the present invention;

FIG. 6 is an exploded perspective view showing a conventional male XSR cable connector; and

FIG. 7 is a sectional view showing a state of assembling the prior art.

### BEST MODE FOR CARRYING OUT THE INVENTION

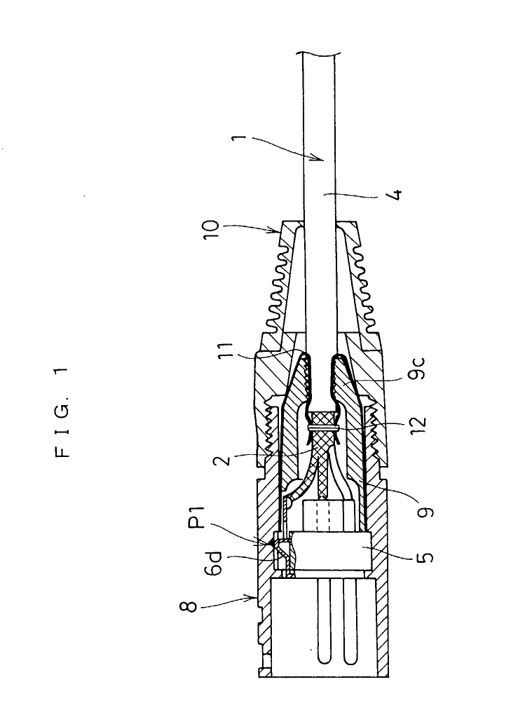

Hereinafter, embodiments of the present invention will be discussed in accordance with FIGS. 1 to 5.

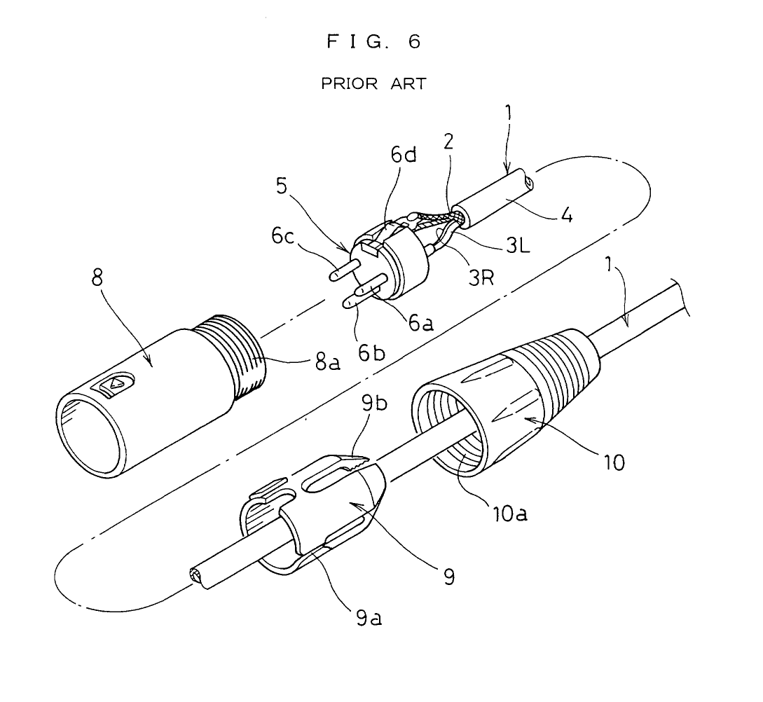

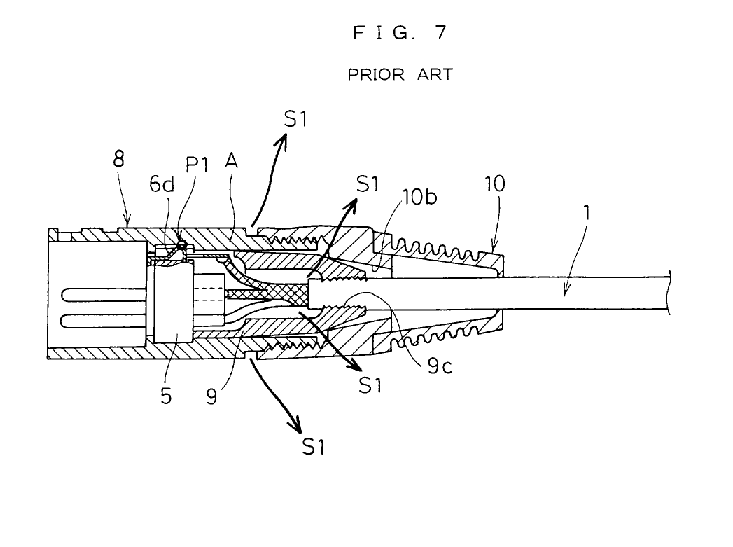

Here, the members having the same functions as those of FIGS. 6 and 7, which illustrate the prior art, will be indicated by the same reference numerals in the following explanation.

Embodiment 1

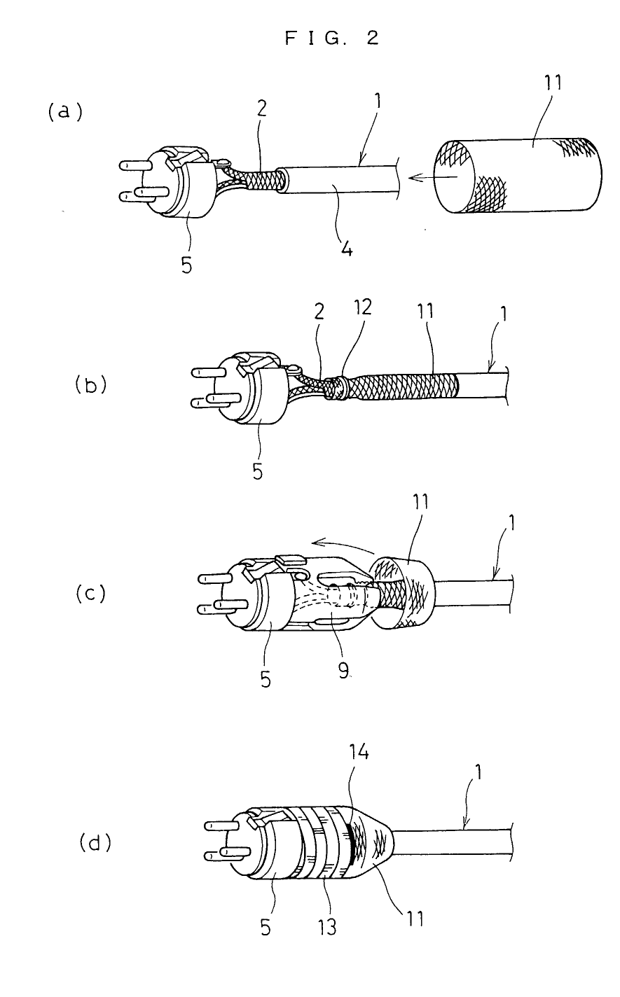

FIGS. 1 and 2 illustrate Embodiment 1 of the-present invention.

In Embodiment 1, as in the prior art, a cable having an outer conductor composed of a single braided wire is used as a cable 1.

First, explanation will be made in accordance with FIGS. 1, 2(a), 2(b), and 2(c).

As shown in FIG. 2(a), in the assembling process, after the cable 1 is soldered to an insert 5 as in the prior art, a braided wire 11 being separate from the cable 1 is placed over the cable 1.

And then, as shown in FIG. 2(b), an end of the braided wire 11 is soldered to an outer conductor 2 of the cable 1. At this point, soldering is carried out after tying is. performed by using a tinned wire 12 and so on.

And then, as shown in FIG. 2(c), a chuck 9 is mounted on the rear of the insert 5, and as shown in FIG. 1, the braided wire 11 passes through the space between an outer jacket 4 of the cable 1 and a rear end portion 9c of the chuck 9 and is drawn from the inside to the outside of the chuck 9.

As shown in FIG. 1, the drawn braided wire 11 is folded on the outer peripheral surface of the chuck 9, the folded braided wire 11 is inserted into a housing 8 together with the insert 5 so as to be interposed between the outer peripheral surface of the chuck 9 and the inner peripheral surface of the housing 8, and a bushing 10 is screwed onto the housing 8, so that the assembling is completed. Here, an interval is small between the housing 8 and the chuck 9. Thus, when the braided wire 11 is disposed in the interval therebetween, the interposed braided wire 11 is disposed between the outer peripheral surface of the chuck 9 and the inner peripheral surface of the housing 8 and the braided wire 11 is pressed over the inner peripheral surface of the housing 8. With this configuration, conduction is produced on the inner peripheral surface of the housing 8 via the braided wire 11 so as to surround the insert 5. Hence, the rear of the insert 5 is shielded more surely than the prior art by the braided wire 11 soldered to an outer conductor 2 of the cable 1.

Here, as to a reduction in extraneous emission of high frequency harmonics nose, an important point is that the outer conductor 2 of the cable 1 is connected to the housing 8 not only at a contact point P1 with a leaf spring terminal 6d but also is in contact with the inner peripheral surface of the housing 8 via the braided wire 11 so as to be brought into conduction. Thus, it is possible to allow the housing 8 to be at the same potential as that of the outer conductor 2 in terms of high frequency waves, thereby remarkably improving extraneous emission of high frequency harmonics nose from the side of the housing 8 as compared with the prior art.

Further, in order to obtain workability when the insert 5 is inserted into the housing 8 and to further reduce extraneous emission, when the insert 5 is inserted into the housing 8, as shown in FIG. 2(d), a conductive tape 13 having an adhesive layer on one surface is wound around the braided wire 11, which is folded on the outer peripheral surface of the chuck 9, while a conducting surface is disposed outside. The conducting surface on an end of the wound conductive tape 13 and the braided wire 11 are brought into conduction via solder 14 and so on, and the insert 5 is inserted into the housing 8 in a state in which the braided wire 11 is temporarily fixed so as not to be rolled up when the insert 5 is inserted into the housing 8.

In this case, the outer conductor 2 of the cable 1 is brought into conduction on the inner peripheral surface of the housing 8 via the braided wire 11 and the conductive tape 13, thereby obtaining the same high frequency performance.

In the example of the conductive tape 13 of the above embodiment, the conducting surface of the conductive tape and the braided wire 11 are in contact with each other via the adhesive layer of the conductive tape 13, so that conduction is not performed. Hence, the conducting surface on the end of the wound conductive tape 13 and the braided wire 11 are brought into conduction via the solder 14 and so on. Here, when a conductive tape is used which has conductive particles mixed in an adhesive layer, it is possible to eliminate the necessity for the solder 14 and it can be expected that the high frequency performance will further improve.

Embodiment 2

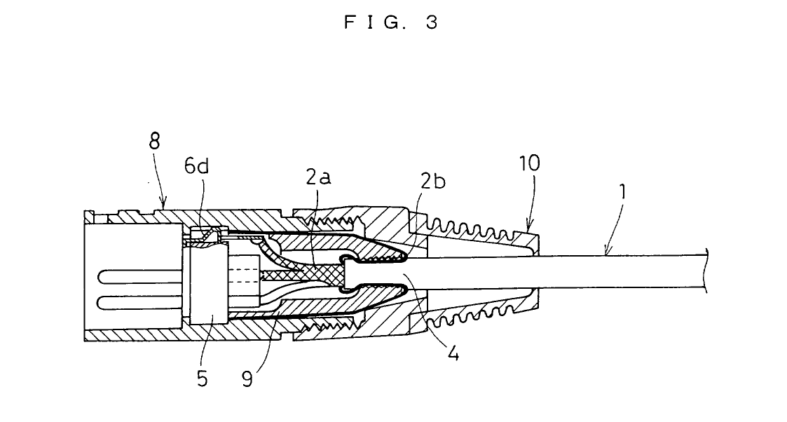

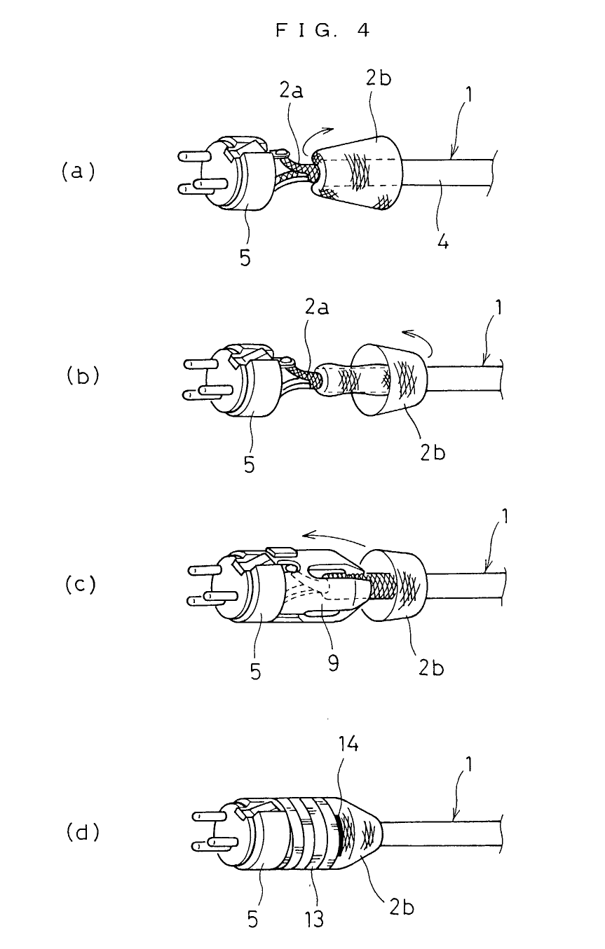

FIGS. 3 and 4 show Embodiment 2 of the present invention.

Embodiment 2 is different from Embodiment 1 only in that a cable having an outer conductor composed of a double braided wire is used as a cable 1.

To be specific, as shown in FIG. 4(a), the cable 1 is composed of an outer conductor 2a on the inside and an outer conductor 2b on the outside. The outer conductor 2a is soldered to a male contact 6c and a leaf spring terminal 6d of an insert 5, and the outer conductor 2b is folded to the rear so as to overlap an outer jacket 4.

And then, as shown in FIGS. 4(b) and 4(c), a chuck 9 is mounted on the rear of the insert 5, and the outer conductor 2b is folded on the outer peripheral surface of the chuck as shown in FIG. 3. Besides, the folded outer conductor 2b is inserted into the housing 8 together with the insert 5 so as to be interposed between the outer peripheral surface of the chuck 9 and the inner peripheral surface of the housing 8, and a bushing 10 is screwed onto the housing 8, so that assembling is completed. Here, an interval is small between the housing 8 and the chuck 9. Thus, when the outer conductor 2b is disposed in the interval therebetween, the interposed outer conductor 2b is disposed between the outer peripheral surface of the chuck 9 and the inner peripheral surface of the housing 8 and the outer conductor 2b is pressed over the inner peripheral surface of the housing 8.

With this configuration, conduction is produced on the inner peripheral surface of the housing 8 via the outer conductor 2b so as to surround the insert 5. Hence, the rear of the insert 5 is shielded more surely than the prior art by the outer conductor 2b of the cable 1.

Here, as to a reduction in extraneous emission of high frequency harmonics nose, an important point is that the outer conductor 2 of the cable 1 is connected to the housing 8 not only at a contact point P1 with the leaf spring terminal 6d but also is brought into conduction on the inner peripheral surface of the housing 8 via the outer conductor 2b. Thus, it is possible to allow the housing 8 to be at the same potential as that of the outer conductor 2 in terms of high frequency waves, thereby remarkably improving extraneous emission of high frequency harmonics nose from the side of the housing 8 as compared with the prior art.

Further, in order to obtain workability when the insert 5 is inserted into the housing 8 and to further reduce extraneous emission, when the insert 5 is inserted into the housing 8, as shown in FIG. 4(d), a conductive tape 13 having an adhesive layer on one surface is wound around the outer conductor 2b, which is folded on the outer peripheral surface of the chuck 9, while a conducting surface is disposed outside. The conducting surface on an end of the wound conductive tape and the outer conductor 2b are brought into conduction via solder 14 and so on, and the insert 5 is inserted into the housing 8 in a state in which the outer conductor 2b is temporarily fixed so as not to be rolled up when the insert 5 is inserted into the housing 8.

In this case, the outer conductor 2 of the cable 1 is brought into conduction on the inner peripheral surface of the housing 8 via the. outer conductor 2b and the conductive tape 13, thereby obtaining the same high frequency performance.

In the example of the conductive tape 13 of the above embodiment, the conducting surface of the conductive tape and the outer conductor 2b are in contact with each other via the adhesive layer of the conductive tape 13, so that conduction is not obtained. Hence, the conducting surface on the end of the wound conductive tape and the outer conductor 2b are brought into conduction via the solder 14 and so on. Here, when a conductive tape is used which has conductive particles mixed in an adhesive layer, it is possible to eliminate the necessity for the solder and further improve the high frequency performance.

Embodiment 3

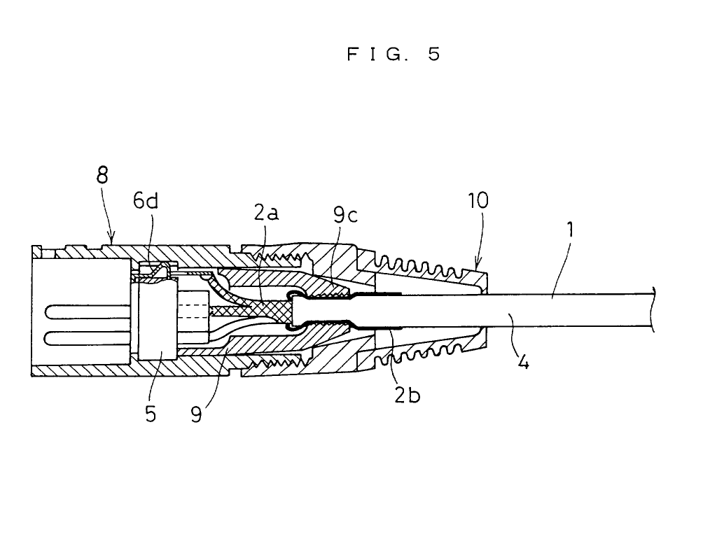

FIG. 5 shows Embodiment 3 of the present invention.

Although the chuck 9 of Embodiment 2 is made of insulating resin as the prior art, a chuck 9 of Embodiment 3. is made of a conductive material, and an outer conductor 2b drawn from the inside to the outside of the chunk 9 is simply interposed between an outer jacket 4 of a cable 1 and a rear end portion 9c of the chuck 9 and is not folded on the outer periphery of the chuck 9.

Additionally, the chuck 9 is somewhat larger in diameter than that of Embodiment 2, and the chuck 9 is pressed over the inner periphery of the housing 8 in a state in which the chuck 9 is inserted into the housing 8 together with the insert 5. Further, a bushing 10 is mounted on the housing 8, so that the rear end portion 9c of the chuck 9 catches and holds an outer jacket 4 of the cable 1 via the outer conductor 2b. Thus, the chuck 9 made of a conductive material and the outer conductor 2b are more surely brought into conduction, and an outer conductor 2a of the cable 1 is brought into conduction on the inner periphery of the housing 8 via the outer conductor 2b and the chuck 9, thereby obtaining the same high frequency performance as Embodiment 2.

The chuck 9 is entirely made of a conductive material in Embodiment 3. The same high frequency performance as Embodiment 2 can also be obtained in the following configuration: the outer peripheral surface of Embodiment 2 that is made of insulating resin is formed, a conductive plated film is continuously formed from the inner surface of the rear end portion 9c to the outer peripheral surface of the chuck 9, and the outer conductor 2a of the cable 1 is brought into conduction on the inner periphery of the housing 8 via the outer conductor 2b and the conductive plated film formed on the chuck 9.

In the examples of Embodiment 3, the chuck 9 is somewhat larger in diameter than that of Embodiment 2, and the chuck 9 is pressed over the inner periphery of the housing 8 in a state in which the chuck 9 is inserted into the housing 8 together with the insert 5. The following configuration is also applicable: the chuck 9 is equal in diameter to that of Embodiment 2, the conductive tape used in Embodiment 2 is wound around the outer periphery of the chuck 9, and the outer periphery of the chuck 9 is pressed over the inner periphery of the housing 8 via the conductive tape. Moreover, in the case where the conductive tape is wound thus around the outer periphery of the chuck 9, as shown in FIG. 4(d), the same effect can be expected by winding the conductive tape around the outer conductor 2b folded on the chuck 9. Also, the same effect can be expected by winding the conductive tape around the chuck 9 instead of folding the outer conductor 2b on the chuck 9.

Besides, in Embodiment 3, a cable having an outer conductor composed of a double braided wire is used as the cable 1. Like Embodiment 1, the combination of the cable 1, which has an outer conductor composed of a single braided wire, and the braided wire 11 is also applicable.

Additionally, in the above described embodiments, a male XSR cable connector was described as an example, and the above description also holds for a female XSR cable connector.

As described above, according to the XSR cable connector of the present invention, the outer conductor of the cable or the conductor connected to the outer conductor extends from the inside to the outside of the chuck through the space between the outer jacket of the cable and the rear end portion of the chuck so as to be interposed between the outer peripheral surface of the chuck and the inner peripheral surface of the housing and so as to be in contact with the housing. Thus, the outer conductor of the cable is in contact with the inner peripheral surface of the housing 8 not at point but on a surface for conduction, allowing the housing to be at the same potential as that of the outer conductor in terms of high frequency waves, remarkably improving extraneous emission of high frequency harmonics nose from the side of the housing as compared with the prior art.

1. An XSR cable connector, in which an outer periphery of an insert having a contact is covered with a conductive housing, a chuck having a leading end being in contact with said insert is inserted into said housing at a rear of said insert, a rear end of said chuck is pressed in an inner periphery of a bushing mounted on a rear end of said housing, and a cable is caught and held by a rear end portion of. said chuck, wherein
an outer conductor of said cable or a conductor connected to said outer conductor extends from an inside to an outside of said chuck through a space between an outer jacket of said cable and said rear end portion of said chuck so as to be interposed between an outer peripheral surface of said chuck and an inner peripheral surface of said housing and said conductor is brought into contact with said housing.

2. The XSR cable connector according to claim 1, wherein a conductive tape is wound around an outer peripheral surface of said chuck via said outer conductor of said cable or said conductor connected to said outer conductor which extends from the inside to the outside of said chuck and is folded on an outer periphery of said chuck, and said conductive tape is brought into contact with said inner peripheral surface of said housing.

3. The XSR cable connector according to claim 1 or 2, wherein said conductor connected to said outer conductor of said cable is a cylindrical braided wire.

4. The XSR cable connector according to claim 1 or 2, wherein said cable has an outer conductor composed of a double braided wire, and an outer braided wire of said outer conductor extends from the inside to the outside of said chuck and is folded on an outer periphery of said chuck.

5. An XSR cable connector, in which an outer periphery of an insert having a contact is covered with a conductive housing, a chuck having a leading end being in contact with said insert is inserted into said housing at a rear of said insert, a rear end of-said chuck is pressed in an inner periphery of a bushing-mounted on a rear end of said housing, and a cable is caught and held by a rear end portion of said chuck, wherein
at least a part of said chuck is made of a conductive material, an outer conductor of said cable or a conductor connected to said outer conductor is interposed between an outer jacket of said cable and a rear end portion of said chuck so as to bring said chuck and said outer conductor of said cable into conduction, and said outer conductor of said cable is brought into contact with an inner peripheral surface of said housing via said chuck.

6. An XSR cable connector, in which an outer periphery of an insert having a contact is covered with a conductive housing), a chuck having a leading end being in contact with said insert is inserted into said housing at a rear of said insert, a rear end of said chuck is pressed in an inner periphery of a bushing mounted on a rear end of said housing, and a cable is caught and held by a rear end portion of said chuck, wherein
at least a part of said chuck is made of a conductive material, an outer conductor of said cable or a conductor connected to said outer conductor is interposed between an outer jacket of said cable and a rear end portion of said chuck so as to bring said chuck and said outer conductor of said cable into conduction, and
said outer conductor of said cable is brought into contact with an inner peripheral surface of said housing via a conductive tape wound around an outer periphery of said chuck.
